(19) United States
(12) Patent Application Publication
(10) Pub. No.: US 2009/0113627 A1
(43) Pub. Date: May 7, 2009

(54) Connector device, bed upright and frame combination and method of use

(76) Inventor: Lawrence Harrow, Commerce, CA (US)

Correspondence Address: CONNORS ASSOCIATES, 1600 DOVE ST, SUITE 220, NEWPORT BEACH, CA, 92660, US

(21) Appl. No.: 11/936,335

(22) Filed: Nov. 7, 2007

(51) Int. Cl. A47C 19/02; F16B 1/00

(52) U.S. Cl. 5/200.1; 403/345

(57) ABSTRACT

A device for connecting a bed frame to a bed upright comprises one component adapted to be attached to a portion of the bed upright in a substantially vertical orientation and the other component adapted to be attached to a portion of the bed frame in a substantially vertical orientation. Each component has a predetermined configuration to enable the components to disengage and engage in an interlocking mating relationship by sliding movement relative to each other.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The word “rectangular” includes square.

### BACKGROUND

Bed uprights, such as headboards and footboards, are attached to a bed frame that supports a box spring and mattress. Commonly, nuts and bolts or other fasteners are used make the attachment. This requires several minutes to install these fasteners, which have to be removed when the bed frames and bed uprights are disconnected. Moreover, frequently other fixtures are needed to make the connection.

### SUMMARY

My connector device simplifies connecting a bed upright to a bed frame. It, and its assembled configuration, components, and method of use have one or more of the features depicted in the embodiments discussed in the section entitled “DETAILED DESCRIPTION OF SOME ILLUSTRATIVE EMBODIMENTS.” The claims that follow define my connector device, and its assembled configuration, components, and method of use, distinguishing them from the prior art; however, without limiting the scope of my connector device, and its assembled configuration, components, and method of use, as expressed by these claims, in general terms, some, but not necessarily all, of their features are:

One, my device for connecting a bed frame to a bed upright includes a pair of components, one component adapted to be attached to a portion of the bed upright in a substantially vertical orientation and the other component adapted to be attached to a portion of the bed frame in a substantially vertical orientation. Each component has a predetermined configuration to enable them to engage and disengage in an interlocking mating relationship by sliding movement relative to each other.

Two, one component may include a channel that is substantially vertically oriented upon attachment. The other component may include a wall structure that is substantially vertically oriented upon attachment and that is sized to be received in an open end of the channel. The channel and wall structure each have a predetermined configuration so that these components engage and disengage in an interlocking mating relationship by sliding movement relative to each other with the wall structure fitting snugly within the channel upon sliding into the channel. The channel component includes guide walls sloping at a first predetermined angle, for example, substantially from 10 to 30 degrees. These guide walls may be substantially mirror images of each other and are of substantially the same dimensions. The height of the guide walls near one open end of the channel are each substantially from ¼ to 1 inch, the height of the walls near the other open end of the channel are each substantially from ⅛ to ¾ inch, the distance between the walls at the one open end is substantially from 1 to 2 inches, and the distance between the walls at the other open end is substantially equal to the distance between the walls at the one open end.

Three, the wall component has walls that slope at a predetermined angle that is substantially the same as the first predetermined angle of the walls of the channel component. These walls of the wall component may be substantially mirror images of each other and are of substantially the same dimensions as the walls of the channel component. In other words, the walls of the wall component and the guide walls are complementary and function to wedge together upon engaging, but may be dislodged by movement in an opposite direction. Gravity normally urges the components together when engaged and a tool such as, for example, a hammer may be required to dislodge the interlocking channel and wall components.

Four, the connector components may be formed by bending a flat metallic sheet into the various part configurations. The wall structure may include an elongated central member having opposed ends and opposed substantially parallel lateral edges. The walls of the wall component are along each lateral edge and at substantially 90 degrees with respect to the central member. These walls of the wall component extend outward in the same direction and each has an edge sloping inwardly from one end to the other opposed end at essentially the same predetermined angle as the guide walls and in the range substantially from 10 to 30 degrees. The central member has along each lateral edge a step that substantially parallels an adjacent wall edge to form a substantially rectangular raised element with a substantially uniform width substantially from ⅜ to 1.25 inch.

Five, the channel component may be formed from a substantially flat metallic sheet bent to configure the channel with a base including opposed outer edges and a wall along each outer edge that is substantially at 90 degrees with respect to the base. The base may be mounted to abut a portion of the bed upright or the bed frame upon attachment thereto. Each wall may terminate in an outer lip member, with the outer lip members pointing inwardly toward each other. The wall component may also be formed from a substantially flat metallic sheet bent to into a wall structure including a central member having opposed outer edges and a wall along each outer edge that is substantially at 90 degrees with respect to the central member. The walls of this wall component slope as discussed above and may be substantially flat and planar.

Six, an attachment element may be connected to an outer surface of either one of the connector components and enables the one component to be connected to the bed frame. This attachment element may be mounted on the outer surface to move laterally relative to the outer surface to adjust spatial orientation. The attachment element may have a pair of legs. One leg may be mounted on the outer surface to move sideways. The other leg may include a pair of spaced apart holes therein along a central longitudinal reference line of this other leg.

My novel combination includes a bed frame, a bed upright, and my connector device.

My method comprises joining a bed frame to a bed upright by aligning two interlocking connector devices and sliding them vertically together. Its steps include

attaching in a vertical orientation to a portion of the bed upright a first connector component including a channel structure that is vertically orientated,

the channel structure including opposed top and bottom ends, with the top end being open, a substantially rectangular base extending between the top and bottom ends and having opposed parallel lateral edges with a wall projecting outward from each lateral edge that is substantially at 90 degrees with respect to the base and extends between the top and bottom ends, each said wall terminating in an outer edge that slops inwardly from the top end to the bottom end at a first predetermined angle and has along said outer edge a lip member,

each wall having substantially the same first predetermined angle, and said lip members pointing inwardly toward each other and each forming a substantially flat ledge, each said ledge terminating in an inner edge with said inner edges spaced apart a substantially uniform predetermined distance to form an open side having a substantially uniform width,

attaching in a vertical orientation to a portion of the bed frame a second connector component including a wall structure having an elongated central member having a top end and bottom end and opposed substantially parallel lateral edges and a wall member along each lateral edge that is substantially at 90 degrees with respect to the central member, with said wall members extending outward in the same direction and each having an edge sloping inwardly from the top end to the bottom end at a second predetermined angle that is substantially equal to said first predetermined angle, said central member having along each lateral edge a step that substantially parallels an adjacent wall edge to form a substantially rectangular raised element with a substantially uniform width that is substantially equal to said width of the open side, said second component including a piece having a substantially right angle attachment element mounted on an outer surface of the central member, and

detachably connecting the first and second connector components by sliding the wall structure of the second component into the channel structure.

These features are not listed in any rank order nor is this list intended to be exhaustive.

### DESCRIPTION OF THE DRAWING

Some embodiments of my connector device, and its assembled configuration, components, and method of use, are discussed in detail in connection with the accompanying drawing, which is for illustrative purposes only. This drawing includes the following figures (Figs.), with like numerals indicating like parts:

FIG. 1 is a fragmentary perspective view of an assembled bed frame and upright using one embodiment of my connector device.

FIG. 1A is a side view of one embodiment of my connector device depicting the initial insertion of one of its components into another of its components.

FIG. 1B is a side view like that of FIG. 1A depicting the partial completion of the insertion of one of the components of my connector device into another of its components.

FIG. 1C is a side view of one embodiment of my connector device like that of FIG. 1A depicting the completion of the insertion of one of the components of my connector device into its other component.

FIG. 2 is an exploded perspective view of the bed frame and upright shown in FIG. 1 prior to assembly.

FIG. 3 is an enlarged, exploded perspective view of one embodiment of my bed frame connector device.

FIG. 3A is a cross sectional view of one component of my connector device.

FIG. 4 is a front elevational view of the embodiment of my connector device shown in FIG. 3, partially disassembled and prior to connecting its components together.

FIG. 5 is a front elevational view similar to that of FIG. 4 with portions of the components of my device conjoined and prior to inserting one component into the other component.

FIG. 6 is a front view of my connector device shown in FIG. 3 with its components connected.

FIG. 7 is a sectional view taken along line 7-7 of FIG. 5.

FIG. 8 is a sectional view taken along line 8-8 of FIG. 6.

FIG. 9 is a front elevational view of an alternate embodiment of my connector device showing prior to inserting one component into the other component.

FIG. 10 is a sectional view taken along line 10-10 of FIG. 9.

FIG. 11 is a side view showing my device depicted in FIG. 9 with its components connected.

FIG. 12 is a cross-sectional view taken along line 12-12 of FIG. 6.

FIG. 13 is a cross-sectional view taken along line 13-13 of FIG. 11.

### DETAILED DESCRIPTION OF SOME ILLUSTRATIVE EMBODIMENTS

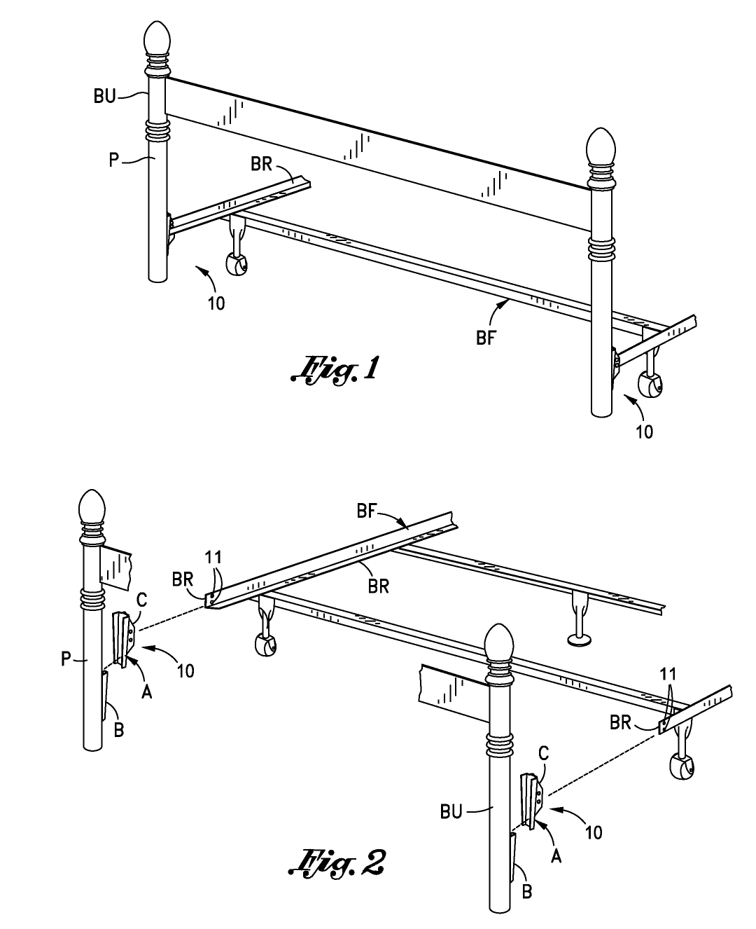

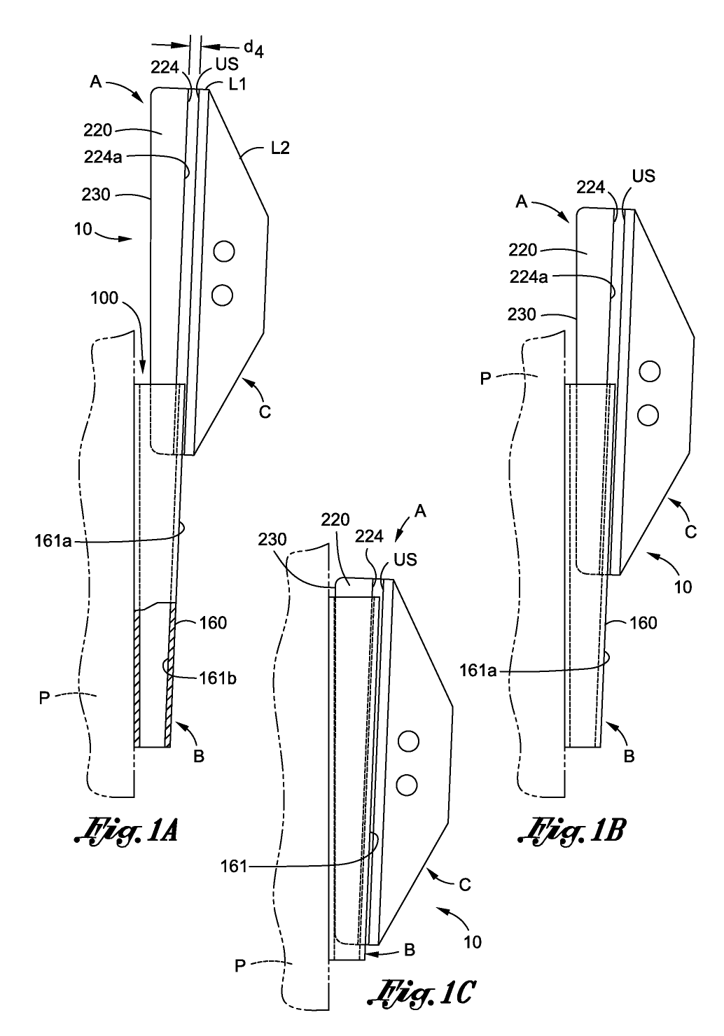

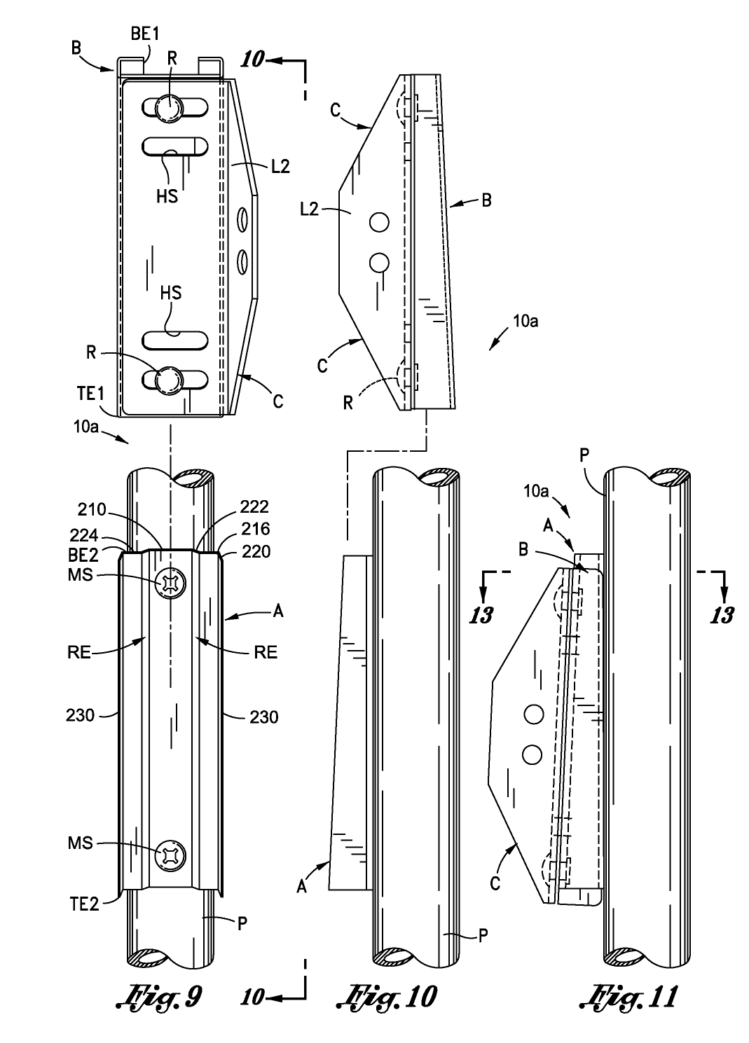

As shown best in FIGS. 1 through 8 and 12, one embodiment of my connector device for connecting a bed frame BF to a bed upright BU is generally designated by the numeral 10. An alternate embodiment of my device generally designated by the numeral 10a is shown in FIG. 9, 10, 11 and 13. In both embodiments, an attachment element C provides a means for connecting my device to the bed frame BF (FIG. 12).

FIGS. 1 through 8, and 12

As shown best in FIGS. 1, 2, 3 and 12, my device 10 utilizes a pair of interlocking components A and B. The component A includes an attachment element C. As discussed subsequently in greater detail, component A and attachment element C are connected together and are normally preassembled and function as a unit, which may be preassembled and attached to an end of a bed rail BR or, at the time of assembling the bed frame BF, the unit is attached to the end of the bed rail. The attachment element C is adapted to be attached and detached to an end portion of a bed rail BR of the bed frame BF using, for example, nuts n and bolts b (FIG. 12) or other suitable fasteners such as rivets. The end portion of the bed rail BR has a pair of aligned vertical holes 11 (FIGS. 12 and 13) that receives nuts n and bolts b connecting the attachment element C to the end of the bed rail BR.

The component B is adapted to be attached and detached to a portion of the bed upright BU, for example, a vertical cylindrical bedpost P, using, for example, metal screws MS or other suitable fasteners or permanently by welding. Upon securely attaching conjoined component A and element C to the bed rail BR and securely attaching component B to the bedpost P, the two components A and B are both vertically oriented. The components A and B respectively have internal and external matching or complimentary configurations enabling them to be detachably connected and disconnected by a sliding, linear motion as illustrated by FIGS. 1A through 1C. The configuration of the individual components A and B enables them through a sliding movement in a one direction, for example a downward direction, to engage in an interlocking, mating relationship. The components A and B may then disengage from the interlocking mating relationship through a sliding movement in the opposite direction, for example an upward direction. Manually sliding the component A into the component B attached securely to the bedpost P, and then fastening the attached element C to the bed rail BR, firmly but detachably connects together the bed frame BF and bed upright BU.

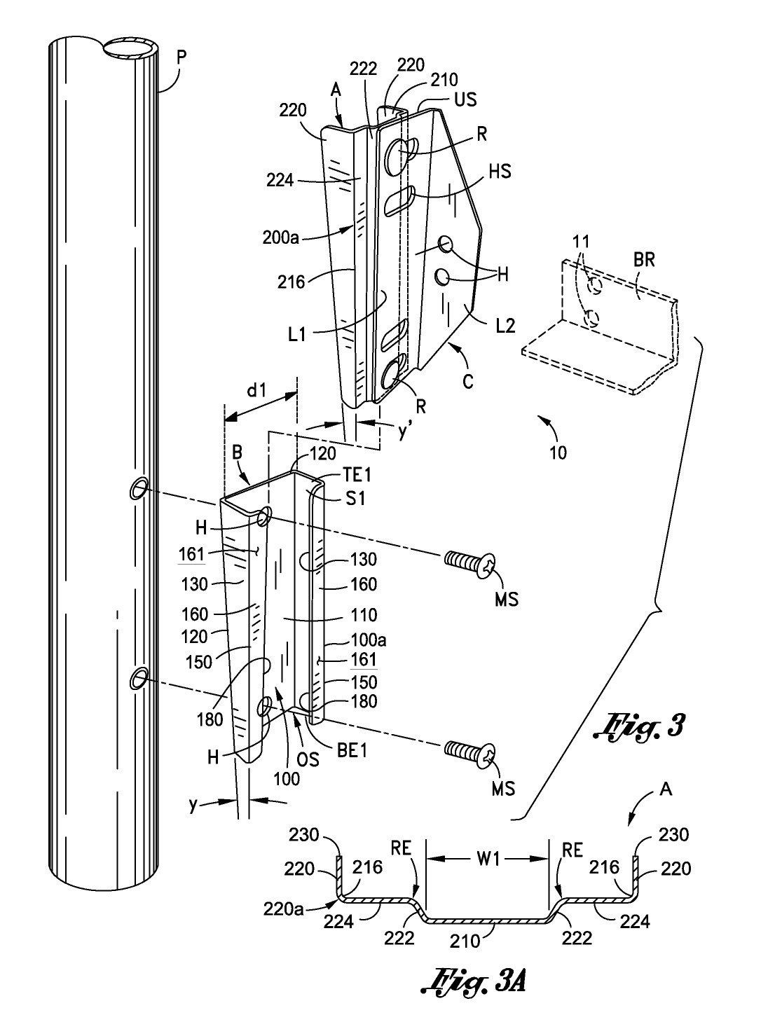

As shown best in FIG. 3, the connector component B is formed from a substantially flat metallic sheet, for example steel, bent into a specific wall structure 100a forming the connector component B so it has a generally C-shaped cross-section to provide an elongated channel 100. The channel 100 is substantially vertically oriented upon attachment of the connector component B to the bedpost P of the bed upright BU. The wall structure 100a has as a substantially rectangular base 110 with a pair of vertically aligned, spaced apart holes H (FIG. 3) punched in the base during formation, an open top end TE1 and an open bottom end BE1. The base 110 has opposed outer lateral edges 120 (FIGS. 3 and 12) and a substantially planar wall 130 along each outer edge 120 that is substantially at 90 degrees with respect to the base 110. The inside surfaces of the planar walls 130 form sides S1 (FIG. 3) of the channel 100.

As best shown in FIGS. 3, 7, and 8, each wall 130 terminates in an outer edge 150. The outer edges 150 of the wall 130 slope downwardly and inwardly from the open top end TE1 to the bottom end BE1 at a predetermined angle Y (FIG. 3) typically substantially from 10 to 30 degrees. Consequently, each wall 130 near the open top end TE1 is wider than near the bottom end BE1. Each wall 130 slopes at substantially the same predetermined angle. Each wall 130 has substantially the same configuration and dimensions, and they are in registration with each other. The distance d₁ (FIG. 3, 12) between the inside surfaces S1 of the walls 130 is substantially uniform along the length of the walls 130. Each wall 130 has along each outer edge 150 a lip member 160 and these lip members point inwardly toward each other. Each lip member 160 forms a substantially flat ledge, with each ledge terminating in an inner edge 180. As depicted in FIG. 4, the inner edges 180 are spaced apart a uniform distance d₂ to form an open side OS in the component B opposite an inner, substantially flat surface of the rectangular base 110. The lip members 160 are substantially at a right angle with respect to the walls 130.

As shown best in FIG. 3 and FIG. 3A, the connector component A is formed from a substantially flat metallic sheet, for example steel, bent to into a shape that enables the component A to be inserted into the component B at the top end TE1 of the channel 100 and slide into the channel in a downward direction, fitting snugly within component B. The component A includes a wall structure 200a sized and configured so it may be inserted into the open top end TE1 of the channel 100 of component B. As shown in FIGS. 3A, 4 and 12, this wall structure 200a includes a substantially rectangular central member 210 having opposed top end TE2 and bottom end BE2 and opposed parallel, lateral edges 216. There is a wall 222 integral with the central member 210 that slants outwardly with respect to the central member 210 and merges with a step 224. The steps 224 lie in the same plane and each one is substantially at a right angle to an adjacent wall 220. The walls 220 terminate in outer edges 230 which are opposite the lateral edges 216. The central member 210, which is straddled by the walls 222 and steps 224, forms a substantially rectangular raised element RE (FIG. 3A) with a substantially uniform width w1 along its length that is about equal to the distance d₂ between the inner edges 180 of component B (FIG. 4). Each of the walls 220 have substantially the same configuration and dimensions and each wall slopes from the top end TE2 to the bottom end BE2 downwardly and inwardly at the predetermined angle Y′ (FIG. 3), which is substantially the same predetermined angle Y as the walls 130 of component B. These walls 220 are in registration with each other. The distance d₃ (FIG. 4) between the outside surfaces of the walls 220 is substantially uniform along the entire length of the walls 220 and is substantially equal to the distance d₁ between the inside surfaces of the walls 130. The walls 130 and 220 are all about the same dimensions, and the two walls 130 are mirror images of each other, and the two walls 220 are mirror images of each other.

As shown in FIGS. 3, 4 and 7, the attachment element C is formed from a substantially flat metallic sheet, for example steel, that is bent once in a single 90-degree angle so the attachment element C comprises of the legs L1 and L2 and has substantially an L-shape cross-section. The leg L1 has punched therein during formation elongated horizontal slots HS aligned in a vertical row. The leg L2 has punched therein during formation a pair of vertically aligned holes H. The pair of aligned holes H enables the leg L2 be secured directly to the bed rail BR. The leg L1 is mounted to the component A, for example, by a pair of rivets R positioned to overlie an outer surface 210a (FIG. 4) of the central member 210. A neck N of each rivet R passes through one of the slots HS in the leg L1 and a head RH, attached to an end of each rivet neck N, protrudes and overlaps the perimeter of the slot HS through which the neck N extends. There is a space between the rivet heads RH and the outer surface 210a of the central member 210 allowing, as indicated by the double headed arrow b in FIG. 6, a side-to-side lateral movement of the attachment element C when mounted to the connector component A. This lateral movement also allows the top end TE2 and bottom end BE2 of the connector component A to be adjusted relative to each other if needed to compensate for any misaligned parts of the bed frame BF. This lateral movement also allows for an easier insertion of component A into the channel 100 of component B if needed to compensate for any misaligned parts.

### Method Of Use

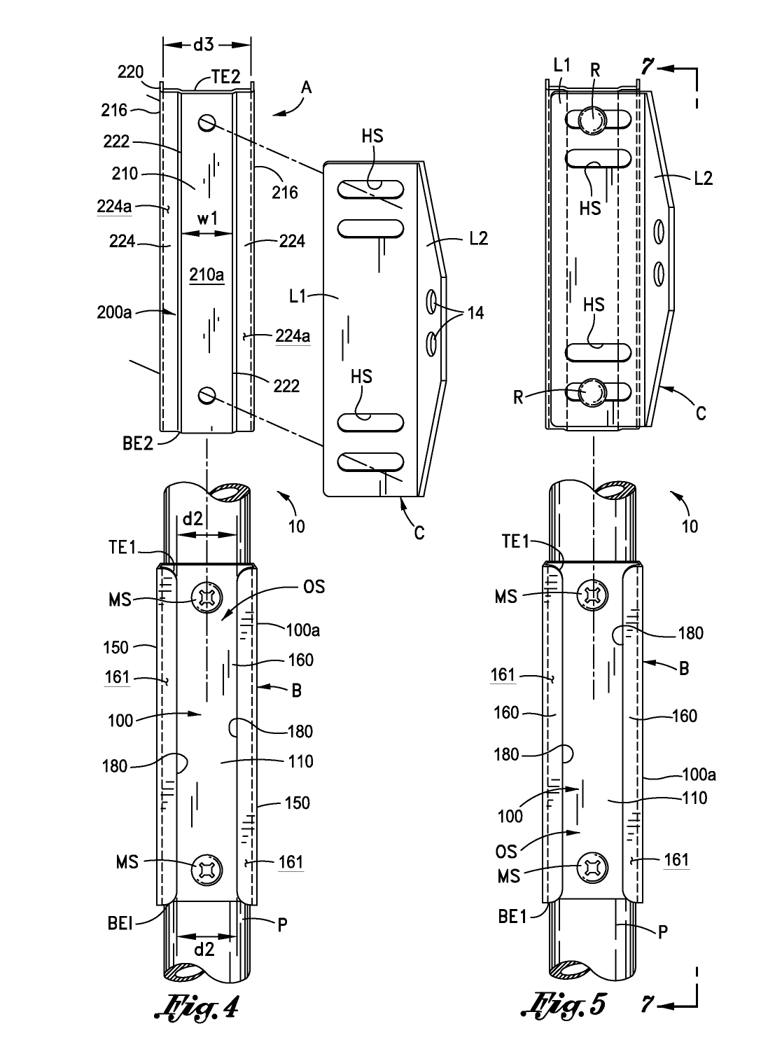

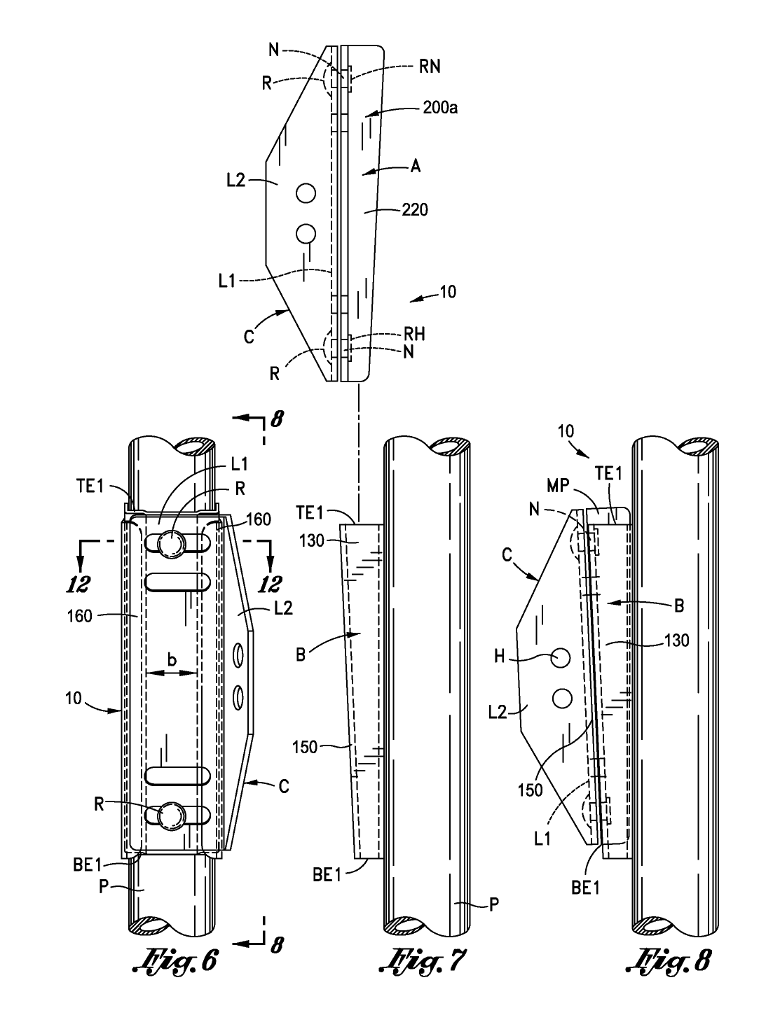

One way to use my device 10, the component B is first attached to the post P, and then component A, which has been preassembled and connected to attachment element C, is manually slid into component B and then the attachment element C is connected to the bed rail. The component A is first manually positioned directly above the open top end TE1 of the channel 100 of component B as illustrated in FIGS. 5 and 7. The component A is moved vertically downward to slide into the open top end TE1 of the channel 100 and is then pushed downward into the channel as illustrated in FIGS. 5 and 7 into a mating, interlocking relationship, with the wall conforming structures 100a and 200a fitting snugly within the channel 100 as best shown in FIGS. 6 and 8 with a minor portion MP of the top end of the component A projecting from the open top end TE1 of the channel 100.

As best illustrated in FIG. 1A, when the component A is moved downward into the channel 100 of the component B ( ) an underside US of the leg L1 of component C rides along top surfaces 161a of the lip members 160 of component B. The distance d₄ between the underside US of the leg L1 and top surfaces of 224a the steps 224 is only slightly greater than the thickness of lip members 160. Concurrently, as the component A is moved downward into the channel 100 of component B, the undersides 161b of the lip members 160 ride over the surfaces 224a the steps 224 of component A. Therefore, the wall structure 100a and the channel 100 of component B engulfs the wall structure 200a of component A.

As the component A is further moved downward into the channel 100 (illustrated in FIG. 1B) the outer edges 230 of the walls 220 of component A come closer to complete parallel contact with the rectangular base 110 of the component B. Finally, the matting relationship of the two components A and B is securely established when the component A is further moved downward into the channel 100 (illustrated in FIG. 1C) the components A and B are then completely interlocked when the outer edges 230 of the wall 220 of component A are in complete contact with the rectangular base 110 of the component B.

To disengage, the components A and B are separated by manually pushing them apart, for example, manually sliding the wall structure 200a of component A upward vertically until the wall structure 200a clears the top open end TE1 of the channel 100 of component A. If attachment element C is attached to the bed rail BR, the components A and B may still be separated by manually pushing them apart by lifting both ends of the bed upright BU including the bedpost P.

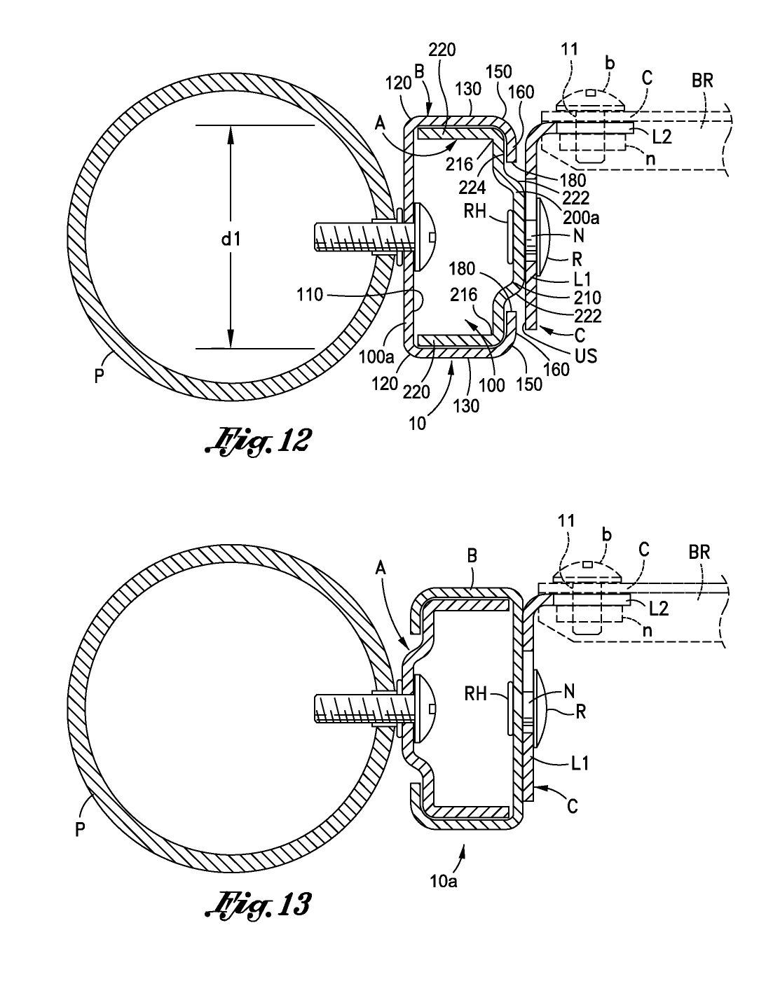

FIGS. 9 through 11 and 13

In the alternate embodiment of my device 10a, component A and component B are both in reverse and inverse positions in regards to embodiment 10. Component A is rotated 180 degrees and is now adapted to be attached and detached to a portion of the bed upright BU, for example, a vertical hollow, cylindrical bedpost P, using, for example, metal screws MS or other suitable fasteners. Upon component A being turned 180 degrees the top end TE2 now points towards the floor while the bottom end BE2 points towards the ceiling. The component B is turned 180 degrees and is now adapted to be attached and detached to the bed frame BF by being joined, for example, by rivets R to the attachment element C. Upon component B being turned 180 degrees the top end TE1 now points towards the floor while the bottom end BE1 points towards the ceiling. The attachment element C, previously attached to component A in embodiment 10, is rotated 180 degrees and is now attached to an exterior surface of the rectangular base 110 of the component B with rivets R in substantially the same manner as the attachment element C was attached to the exterior surface 210 of the component A as discussed above. Specifically, the rivets R pass through holes H (not shown) in the rectangular base 110 of component B and into the horizontal slots HS in the leg L1 of the attachment element C. The attachment element C is able to move laterally from side-to-side with respect to the base 110 of component B. The attachment element C is then attached to the end of the bed rail BR substantially in a vertically orientation as discussed above.

Upon attachment to the bed post P, of the bed upright BU, the inverted component A is then in a substantial vertical orientation with the bed post P (FIG. 10). As the top end TE1 of the wall structure 100a of component B, which is now facing downwards toward the floor, is slid around the bottom end BE2 and moved downward along the wall structure 200a of component A (FIG. 10 & 11), the channel 100 of the component B engulfs the wall structure 200a of component A as the underside of the lip members 160 of component B ride along steps 224 of component A. As the component B is further moved downward around the wall structure 200a of component A the outer edges 230 of the walls 220 of component A come closer to complete parallel contact with the rectangular base 110 of the component B. Finally, the matting relationship of the two components A and B is securely established when the components A and B are then completely interlocked when the outer edges 230 of the wall 220 of component A are in complete contact with the rectangular base 110 of the component B.

To disengage, the components A and B are separated by manually pushing them apart, for example, manually sliding the wall structure 100a of component B upward vertically until the wall structure 100a clears the bottom end BE2 of the channel 100 of component B. If attachment element C is still attached to the bed rail BR of the bed frame BF the components A and B may still be separated by manually pushing them apart by lifting both ends of the bed upright BU including its bedposts P.

### SUMMARY

Thus, the tapered/wedge configuration of the interlocking components A and B, along with the force of gravity allow for a quick, adjustable assembly and disassembly of the bed frame BF to the bed upright BU that is secure and safe. Furthermore, the reduction in parts and time saved in the installation of the bed upright to the bed frame is advantageous.

### Scope of the Invention

The above presents a description of the best mode I contemplate of my connector device and of the manner and process of making and using it, in such full, clear, concise, and exact terms as to enable any person skilled in the art to which it pertains to make and use my connector device. My connector device is, however, susceptible to modifications and alternate constructions from the illustrative embodiments discussed above which are fully equivalent. Consequently, it is not the intention to limit my connector device to the particular embodiments disclosed. On the contrary, my intention is to cover all modifications and alternate constructions coming within the spirit and scope of my connector device as generally expressed by the following claims, which particularly point out and distinctly claim the subject matter of my invention:

1. A device for connecting a bed frame to a bed upright comprising
a pair of components, one component adapted to be attached to a portion of the bed upright in a substantially vertical orientation and the other component adapted to be attached to a portion of the bed frame in a substantially vertical orientation,
each said component having a predetermined configuration to enable said components to disengage and engage in an interlocking mating relationship by sliding movement relative to each other.

2. A device of claim 2 where
one component includes a channel that is substantially vertically oriented upon attachment and the other component includes a wall structure that is substantially vertically oriented upon attachment and is sized to be received in said open end of the channel,
said channel and wall structure each having a predetermined configuration so that said channel component and wall component engage and disengage in an interlocking mating relationship by sliding movement relative to each other with the wall structure fitting snugly within the channel upon sliding into the channel.

3. The device of claim 2 where
the channel component is formed from a substantially flat metallic sheet bent to configure the channel with a base including opposed outer edges and a wall along each outer edge that is substantially at 90 degrees with respect to the base, each said wall terminating in an outer lip member, said outer lip members pointing inwardly toward each other,
each said channel wall slopes at a first predetermined angle from one open end of the channel to an opposed open end of the channel and said channel walls have substantially the same configuration and dimensions, and
the wall component is formed from a substantially flat metallic sheet bent to into a wall structure including a central member having opposed outer edges and a guide wall along each outer edge that is substantially at 90 degrees with respect to the central member,
said guide walls sloping from one end to an opposed end at a predetermined angle that is substantially the same as said first predetermined angle and each said guide wall having substantially the same configuration and dimensions as those of the channel walls.

4. The device of claim 3 where the walls are substantially flat and planar.

5. The device of claim 3 including an attachment element connected to one component to be detachably connected to the bed frame or bed upright.

6. The device of claim 5 where the attachment element is mounted on an outer surface of said one component to move laterally relative to the outer surface to adjust orientation.

7. A device for connecting a bed frame to a bed upright comprising
a first connector component adapted to be attached in a vertical orientation and formed from a substantially flat metallic sheet bent into a channel structure including opposed top and bottom ends, with said top end being open, a substantially rectangular base extending between the top and bottom ends and having opposed parallel lateral edges with a wall projecting outward from each lateral edge that is substantially at 90 degrees with respect to the base and extends between the top and bottom ends, each said wall terminating in an outer edge that slops from one end to another end at a first predetermined angle and having along said outer edge a lip member, each wall having substantially the same first predetermined angle, and said lip members pointing inwardly toward each other and each forming a substantially flat ledge, each said ledge terminating in an inner edge with said inner edges spaced apart a substantially uniform predetermined distance to form an open side having a substantially uniform width, and
a second component formed by bending a flat metallic sheet into a wall structure including an elongated central member having a top end and bottom end and opposed substantially parallel lateral edges and a wall member along each lateral edge that is substantially at 90 degrees with respect to the central member, with said wall members extending outward in the same direction and each having an edge sloping inwardly from one end to another end at a second predetermined angle that is substantially equal to said first predetermined angle, said central member having along each lateral edge a step that substantially parallels an adjacent wall edge to form a substantially rectangular raised element with a substantially uniform width that is substantially equal to said width of the open side.

8. The device of claim 7 including a piece connected to one component, either said first component or said second component, and adapted to be attached to a portion of the bed frame or bed upright to orient said one component vertically, said piece being formed by bending a flat metallic sheet into a substantially right angle attachment element mounted on an outer surface the one component to move laterally relative to the outer surface.

9. The device of claim 7 where said first and second predetermined angles are each substantially from 10 to 30 degrees.

10. A connector component formed from a substantially flat metallic sheet bent into a channel structure including first and second opposed open ends, a substantially rectangular base extending between the open ends and having opposed lateral edges, a tapering wall along each lateral edge that is substantially at 90 degrees with respect to the base, said walls being substantially mirror images and of substantially the same dimensions with the distance between the walls being substantially uniform, each tapering wall extending lengthwise between the opposed open ends and having an outer lip member, said outer lip members pointing inwardly toward each other and each forming a substantially flat ledge, each said ledge terminating in an inner edge with said inner edges spaced apart to form an open side in the channel structure opposite an inner substantially planar surface of the base, said lateral edges being spaced apart a distance that is substantially uniform along the length of the edges.

11. The connector component of claim 10 where the height of the walls near one open end of the channel are each substantially from ¼ to 1 inch, the height of the walls near the other open end of the channel are each substantially from ⅛ to ¾ inch, the distance between the walls at the one open end is substantially from 1 to 2 inches, and the distance between the walls at said other open end is substantially equal to the distance between the walls at the one open end.

12. A connector component formed by bending a flat metallic sheet into a wall structure including an elongated central member having opposed ends and opposed substantially parallel lateral edges and a wall member along each lateral edge that is substantially at 90 degrees with respect to the central member, with said wall members extending outward in the same direction and each having an edge sloping inwardly from one end to the other opposed end at a predetermined angle, said central member having along each lateral edge a step that substantially parallels an adjacent wall member edge to form a substantially rectangular raised element with a substantially uniform width.

13. The connector component of claim 12 the uniform width of the rectangular raised element is substantially from ⅜ to 1.25 inch.

14. The combination including
a bed frame,
a bed upright, and
means for connecting the bed frame and a bed upright including a pair of connector components,
means for detachably connecting one connector component in a vertical orientation to the bed frame, and
means for detachably connecting the other connector component in a vertical orientation to the bed upright,
said pair of connector components including means for disengaging and engaging with each other in an interlocking mating relationship by sliding movement relative to each other.

15. Method of attaching together a bed upright and a bed frame, the method comprising the steps of
attaching in a vertical orientation to a portion of the bed upright a first connector component including a channel structure that is vertically orientated,
said channel structure including opposed top and bottom ends, with said top end being open, a substantially rectangular base extending between the top and bottom ends and having opposed parallel lateral edges with a wall projecting outward from each lateral edge that is substantially at 90 degrees with respect to the base and extends between the top and bottom ends, each said wall terminating in an outer edge that slops inwardly from the top end to the bottom end at a first predetermined angle and has along said outer edge a lip member,
each wall having substantially the same first predetermined angle, and said lip members pointing inwardly toward each other and each forming a substantially flat ledge, each said ledge terminating in an inner edge with said inner edges spaced apart a substantially uniform predetermined distance to form an open side having a substantially uniform width,
attaching in a vertical orientation to a portion of the bed frame a second connector component including a wall structure having an elongated central member having a top end and bottom end and opposed substantially parallel lateral edges and a wall member along each lateral edge that is substantially at 90 degrees with respect to the central member, with said wall members extending outward in the same direction and each having an edge sloping inwardly from the top end to the bottom end at a second predetermined angle that is substantially equal to said first predetermined angle, said central member having along each lateral edge a step that substantially parallels an adjacent wall edge to form a substantially rectangular raised element with a substantially uniform width that is substantially equal to said width of the open side, said second component including a piece having a substantially right angle attachment element mounted on an outer surface of the central member, and
detachably connecting the first and second connector components by sliding the wall structure of the second component into the channel structure.
